(19) United States
(12) Patent Application Publication
(10) Pub. No.: US 2007/0236465 A1
(43) Pub. Date: Oct. 11, 2007

(54) FACE PANEL MOUNTING STRUCTURE

(75) Inventors: Miao Tzu Chou, San-Hsia Town (TW); Chia-Yen Hsu, Hsin-Chuang City (TW); Chia-Chuan Wu, Chungho City (TW)

Correspondence Address: DATAVAN INTERNATIONAL CORP., P.O. BOX 108-00403, TAIPEI, TW

(73) Assignee: DATAVAN INTERNATIONAL CORP., Jhonghe City (TW)

(21) Appl. No.: 11/279,116

(22) Filed: Apr. 10, 2006

(51) Int. Cl. G06F 3/041

(52) U.S. Cl. 345/173

(57) ABSTRACT

A face panel mounting structure includes a base frame, which is mountable on a front side of a LCD monitor and has a plurality of locating grooves at one side thereof, a face panel, and a packing member, which has a back bonding surface bonded to a border area of a front side of the face panel and a plurality of compressible locating blocks protruding from the front side thereof and respectively press-fitted into the locating grooves of the base frame to detachably secure the face panel to the base frame in a watertight manner.

### BACKGROUND OF THE INVENTION

1. Field of the Invention

The present invention relates to a face panel mounting structure and more particularly, to a face panel mounting structure, which is detachable and has airtight, waterproof and dustproof characteristics.

2. Description of the Related Art

Following fast development of electronic technology, information industry and network communication technology, information products such as computer, mobile telephone, PDA, and etc., have become the requisites of many people in daily life. A digital information product has a display screen for data output and an input device for data input. From early CRT design to the present LCD design, it is the market tendency to develop products having light, think short and small characteristics. With respect to input device, keyboard and mouse are commonly used in information products for data input.

In recent years, touch-panel display has been well developed. A touch-panel display uses a touch panel to substitute for a keyboard or mouse for data input. By means of a finger or a touch pen, the user can input instructions through the touch panel. Touch-panel display is intensively used in industrial computers, ATMs (Auto Teller Machines), information inquiry systems, mobile telephones, PDAs (Personal Digital Assistants). A touch panel makes an information product humanized and easy to use.

Further, subject to touch point detection method, conventional touch-panel screens include three types, namely, the resistive type, the capacitive type, and the fluctuation type. When touched a resistive type touch-panel screen with a finger or touch pen, a voltage is induced at the touched point. When touched a capacitive type touch-panel screen with a finger, the finger will induce a current. A fluctuation type touch-panel screen covers the whole screen surface with a sound wave or infrared. When touching a fluctuation type touch-panel screen with a finger or touch pen, the finger or touch pen will block the standing wave pattern. The resistive type is the most popularly accepted design for the advantages of wide range of application and lowest cost. Further, a resistive type touch-panel screen accepts any of a variety of objects (finger, pen, and etc.).

As the touch-panel screen of a LCD monitor works as an instruction input medium for a computer for allowing the user to input instructions into the computer, the surface of the touch-panel screen wears quickly with use. When the surface of the touch-panel screen is damaged, it must be replaced.

FIG. 7 is a sectional view of a part of a conventional touch-panel display. As illustrated, the touch-panel display comprises a housing A and a front cover A1. The front cover A1 holds a touch panel C, which is bonded to the front cover A1 with a double-sided adhesive tape C1. The housing A houses a display module B. The front cover A1 is mounted on the front side of the housing A. When the touch panel C is damaged after a long use, the front cover A1 must be removed from the housing A so that a new touch panel C can be installed to replace the damaged touch panel C.

This design of touch-panel display has drawbacks as follows:

1. After removal of the damaged touch panel C from the front cover A1, a new double-sided adhesive tape C1 must be used to adhere the new touch panel C to the front cover A1.

2. After removal of the double-sided adhesive tape C1, the touch panel C will have residual adhesive that causes contamination. It takes much time and labor to clean the touch panel C. When cleaning the residual adhesive with a tool, the tool may scratch the surface of the touch panel C accidentally.

Further, when a new double-sided adhesive tape is used to adhere the repaired touch panel to the front cover, the following problems may occur:

1. Gaps may exist in between the front cover A1 and the touch panel C after adhesive of the double-sided adhesive tape C1 between the front cover A1 and the touch panel C, and dust or moisture may pass through the gaps in between the front cover A1 and the touch panel C into the inside of the display module B of the touch-panel display, resulting in damage to the internal electronic component parts.

2. It is difficult to precisely adhere the double-sided adhesive tape C1 to the touch panel C along the four sides, and gaps will exist in each corner between the front cover A1 and the touch panel C through which dust and moisture will pass to the inside of the display module B of the touch-panel display.

In another conventional design, screws are used to affix the touch panel to the front cover. However, this touch panel mounting method still has drawbacks as follows:

1. During installation, the screws must be properly fastened up. If the screws are fastened excessively tight, the screws may damage the local part of the touch panel C. If the screws are not fastened tight, they may be loosened and may fall from the touch panel C accidentally, causing vibration of the touch panel C.

2. When a touch panel C maintenance or replacement work is necessary, it takes much time to remove the screws. Further, because the screws have a mini size, they may fall to the ground and not to be found during the mounting or dismounting process.

Therefore, it is desirable to provide a touch panel mounting structure that eliminates the aforesaid drawbacks.

### SUMMARY OF THE INVENTION

The present invention has been accomplished under the circumstances in view. It is one object of the present invention to provide a face panel mounting structure, which allows quick mounting/dismounting of the face panel. It is another object of the present invention to provide a face panel mounting structure, which has waterproof and dustproof characteristics. It is still another object of the present invention to provide a face panel mounting structure, which allows quick mounting/dismounting of the face panel without any tools.

To achieve these and other objects of the present invention, the face panel mounting structure comprises a base frame mountable on a front side of a LCD monitor, the base frame having a plurality of locating grooves at one side thereof, a face panel; and a packing member, the packing member having a back bonding surface bonded to a front side of the face panel along a border of the face panel and a plurality of compressible locating blocks protruding from a front side thereof and respectively press-fitted into the locating grooves of the base frame to detachably secure the face panel to the base frame.

### BRIEF DESCRIPTION OF THE DRAWINGS

FIG. 1 is an elevational view of a face panel mounting structure according to the present invention.

FIG. 2 is an exploded view of the face panel mounting structure according to the present invention.

FIG. 2A is an enlarged view of part A of FIG. 2.

FIG. 2B is an enlarged view of part B of FIG. 2.

FIG. 3 is a sectional side view of the present invention showing the relationship of the parts of the face panel mounting structure before assembly.

FIG. 4 is a sectional view in an enlarged scale of a part of the assembly of the face panel mounting structure according to the present invention.

FIG. 5 is another elevational view of the face panel mounting structure according to the present invention when viewed from another angle.

FIG. 5A is a sectional elevation of a part of the face panel mounting structure according to the present invention.

FIG. 6 is a schematic drawing showing an application example of the present invention.

FIG. 7 is a sectional side view of a part of a conventional touch-panel type LCD monitor.

### DETAILED DESCRIPTION OF THE INVENTION

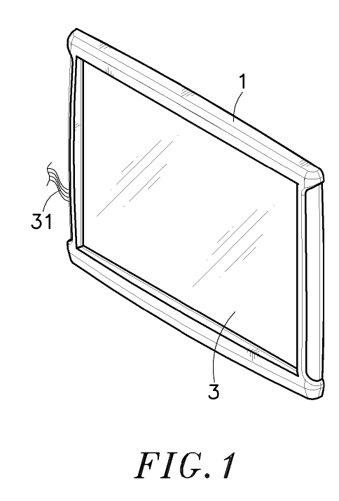

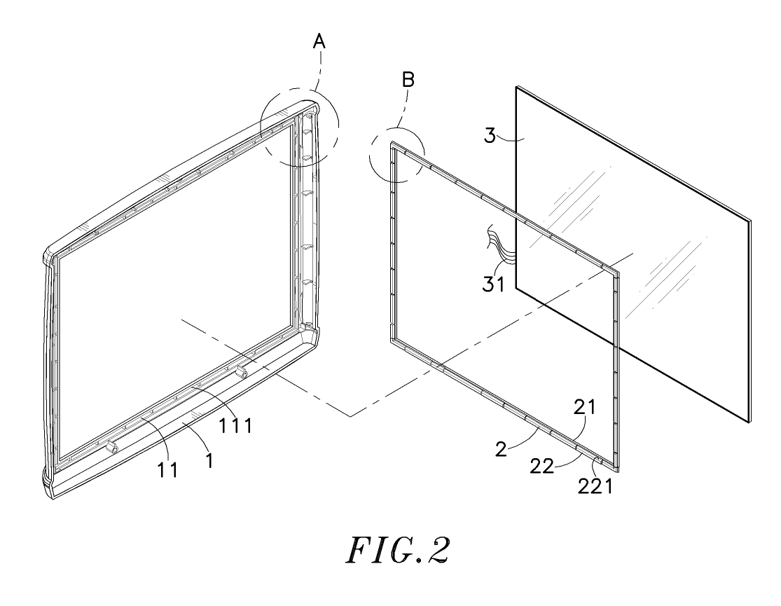

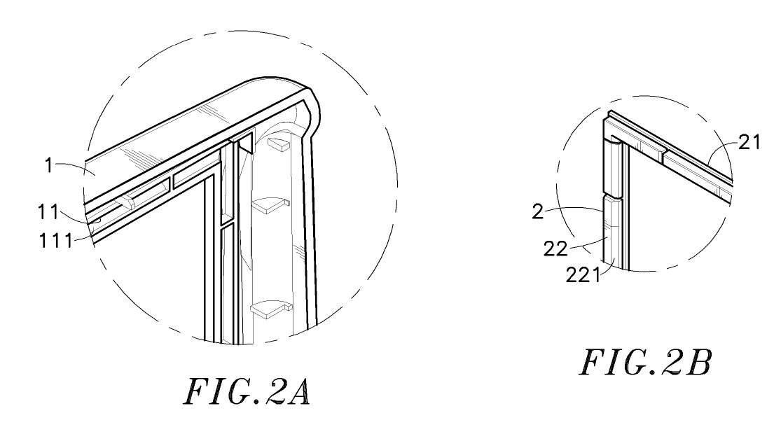

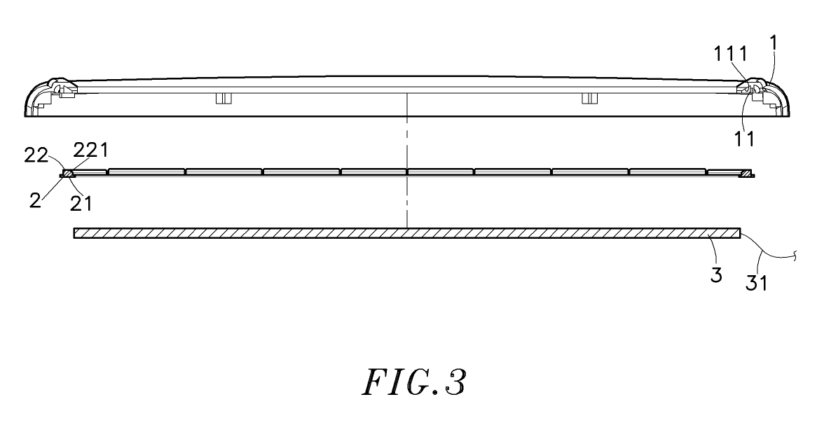

Referring to FIGS. 1, 2, 2A, and 2B, a face panel mounting structure in accordance with the present invention is shown comprising a base frame 1, a packing member 2, and a face panel 3.

The base frame 1 is a flat open frame. According to this embodiment, the base frame 1 is a rectangular open frame having a plurality of locating grooves 11 arranged around an inner diameter (center opening). Each locating groove 11 has a beveled guide face 111.

The packing member 2 is an elastomeric member fitting the configuration of the base frame 1. Preferably, the packing member 2 is made of rubber or silicon rubber. Further, the packing member 2 has a bonding surface 21 at one side and a plurality of locating blocks 22 at the opposite side corresponding to the locating grooves 11 of the base frame 1. The locating blocks 22 are relatively slightly greater than the locating grooves 11 in size so that the locating blocks 22 are firmly secured to the locating grooves 11 when squeezed into the locating grooves 11 with force. Further, each locating block 22 has a beveled guide face 221 fitting the beveled guide face 111 of the associating locating groove 11. The bonding surface 21 of the packing member 2 is covered with bonding means 211 and then bonded to a border area of a back side of the face panel 3. The bonding means 211 can be a double-sided adhesive tape, glue, or waterproof bonding agent.

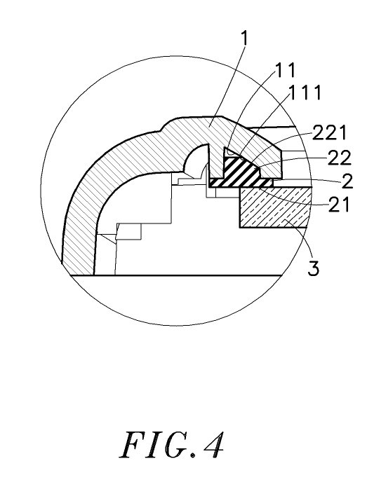

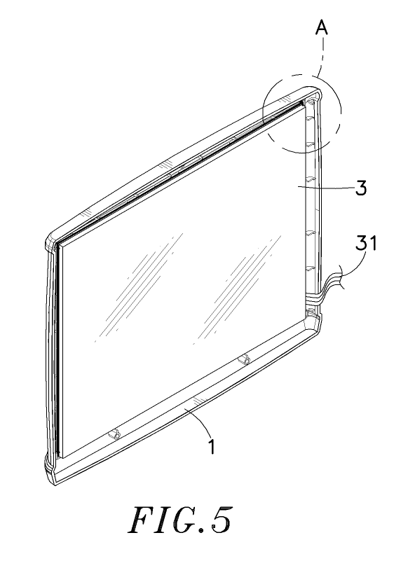

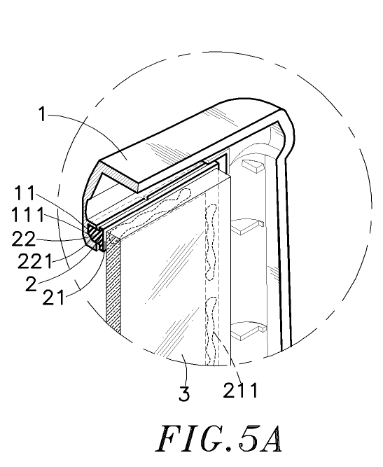

Referring to FIGS. 3, 4, 5, and 5A, during installation, the bonding surface 21 of the packing member 2 is covered with the bonding means 211 and then bonded to the border area of the back side of the face panel 3. Thereafter, the packing member 2 with the bonded face panel 3 are aimed at the back side of the base frame 1 with the beveled guide face 221 of each locating block 22 of the packing member 2 respectively attached to the beveled guide face 111 of each locating groove 11 of the base frame 1, and then a forward pressure is applied to the face panel 3 and the packing member 2 against the base frame 1 to deform the locating blocks 22 of the packing member 2 and to further force the deformed locating blocks 22 into the locating grooves 11 of the base frame 1 respectively (see FIGS. 5 and 5A). Because the locating blocks 22 are respectively greater than the locating grooves 11 in size, the packing member 2 effectively seals the gap between the base frame 1 and the face panel 3 against dust and water after engagement of the respective locating blocks 22 into the respective locating grooves 11. When pushing the face panel 3 backwards relative to the base frame 1, the locating blocks 22 of the packing member 2 will be respectively disengaged from the locating grooves 11 of the base frame 1, allowing replacement or repair of the face panel 3.

Further, after separation of the face panel 3 and the packing member 2 from the base frame 1, a repair work can directly be employed to the face panel 3 without detaching the packing member 2 from the face panel 3. By means of the packing member 2, the repaired face panel 3 can be directly installed in the base frame 1 again. Further, the face panel 3 and the packing member 2 can be modularized. When the face panel 3 is damaged, the whole module of the face panel 3 and the packing member 2 can be directly replaced with a new module. Therefore, the invention allows quick mounting/dismounting of the face panel 3.

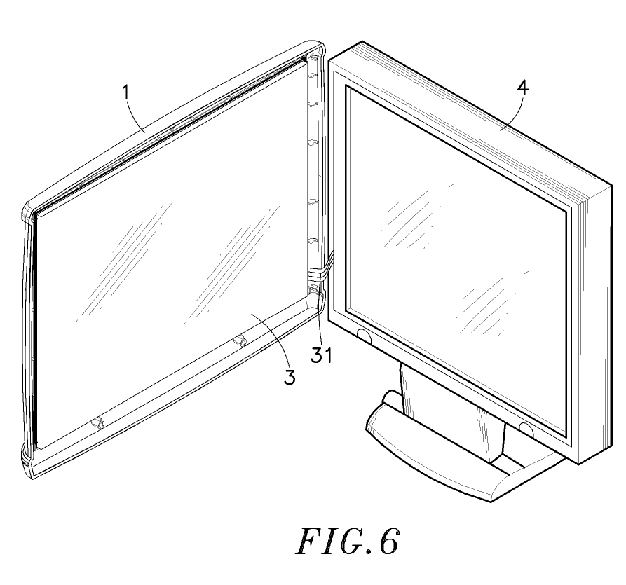

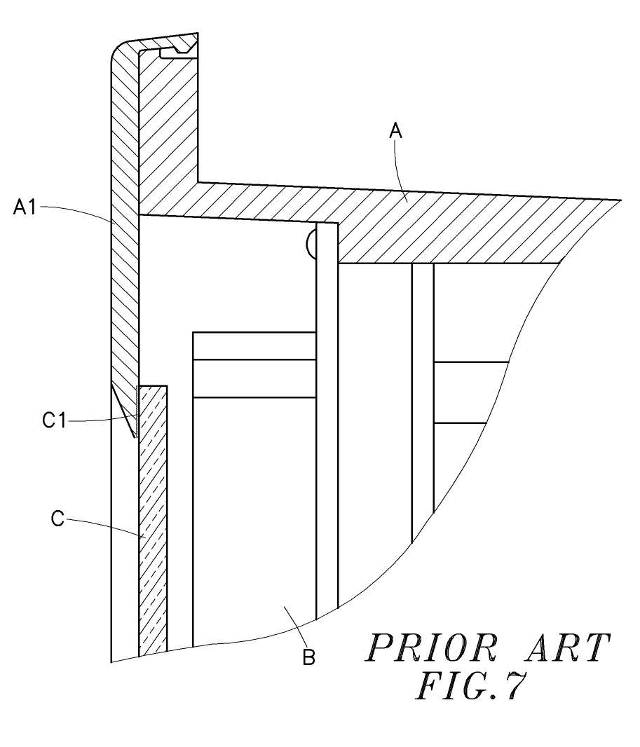

FIG. 6 shows an application example of the present invention. As illustrated, the face panel mounting structure of the present invention is used in a LCD monitor 4. The face panel 3 is mounted on a front side of the LCD monitor 4 and affixed thereto with screws, having a signal line 31 electrically connected to an internal circuit board of the LCD monitor 4. The face panel 3 of the present invention can be a transmittance glass, reinforced glass, or touch panel. According to this application example, the face panel 3 is a touch panel. Through the face panel (touch panel) 3, the user can input instructions into the LCD monitor 4.

As indicated above, the invention provides a face panel mounting structure, which comprises a base frame 11, which has a plurality of locating grooves 11 on the back side around the center opening and a beveled guide face 111 at each locating groove 11, a face panel 3, and an elastomeric packing member 2, which has a back bonding surface 21 directly bonded to the border area of the front side of the face panel 3 and a plurality of front locating blocks 22 respectively forced into engagement with the locating grooves 11. The locating blocks 22 are relatively greater than the locating grooves 11, each having a beveled guide face 221 that fits the beveled guide face 111 of the associating locating groove 11 for guiding the respective locating block 22 into positive engagement with the associating locating groove 11.

The face panel mounting structure of the present invention has the following characteristics:

1. By means of forcing the locating blocks 22 of the packing member 2 into engagement with the corresponding locating grooves 11 of the base frame 1, the face panel 3 is fastened to the base frame 1 firmly. Simply by pushing the face panel 3 backwards from the base frame 1, the face panel 3 and the packing member 2 are disconnected from the base frame 1 for a repair work or replacement.

2. The elastomeric locating blocks 22 of the packing member 2 are respectively pressed into the relatively smaller locating grooves 11 of the base frame 1, thereby providing airtight, waterproof and dustproof characteristics.

3. The face panel 3 can easily and quickly be installed in or detached from the base frame 1 without any tools, preventing damage to the surface of the face panel 3 during mounting/dismounting.

A prototype of detachable face panel mounting structure has been constructed with the features of FIGS. 1˜6. The detachable face panel mounting structure functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A face panel mounting structure comprising:
a base frame mountable on a front side of a LCD monitor, said base frame having a plurality of locating grooves at one side thereof;
a face panel; and
a packing member, said packing member having a back bonding surface bonded to a front side of said face panel along a border of said face panel and a plurality of compressible locating blocks protruding from a front side thereof and respectively press-fitted into the locating grooves of said base frame to secure said face panel to said base frame.

2. The face panel mounting structure as claimed in claim 1, wherein said locating grooves of said base frame each have a beveled guide face; said locating blocks of said packing member each have a beveled guide face respectively fitting the beveled guide faces of said locating grooves of said base frame.

3. The face panel mounting structure as claimed in claim 1, wherein said packing member is made of an elastomeric rubber material.

4. The face panel mounting structure as claimed in claimed 1, wherein said packing member is made of an elastomeric silicon rubber.

5. The face panel mounting structure as claimed in claim 1, wherein said back bonding surface of said packing member is bonded to said face panel with a double-sided adhesive tape.

6. The face panel mounting structure as claimed in claim 1, wherein said back bonding surface of said packing member is bonded to said face panel with a waterproof bonding agent.

7. The face panel mounting structure as claimed in claim 1, wherein said face panel is a transmittance glass.

8. The face panel mounting structure as claimed in claim 1, wherein said face panel is a reinforced glass.

9. The face panel mounting structure as claimed in claim 1, wherein said face panel is a touch panel.
